(19) United States
(12) Patent Application Publication
(10) Pub. No.: US 2020/0011410 A1
(43) Pub. Date: Jan. 9, 2020

(54) OIL SUPPLY DEVICE

(71) Applicant: AISIN AW CO., LTD., Anjo-shi, Aichi-ken (JP)

(72) Inventors: Tetsuya SHIMIZU, Anjo (JP); Toru SUGIYAMA, Anjo (JP); Keiji Suzuki, Anjo (JP); Yuya ISHIHARA, Nishio (JP); Masaya IWATA, Okazaki (JP); Shinya ICHIKAWA, Anjo (JP)

(73) Assignee: AISIN AW CO., LTD., Anjo-shi, Aichi-ken (JP)

(21) Appl. No.: 16/490,265

(22) PCT Filed: Mar. 30, 2018
(86) PCT No.: PCT/JP2018/013751

§ 371 Date: Aug. 30, 2019

(30) Foreign Application Priority Data
Mar. 31, 2017 (JP) 2017-070520

(51) Int. Cl. F16H 57/04; B60K 6/20; F16N 7/38; F16N 39/02; B60K 6/22

(52) U.S. Cl. CPC F16H 57/0434; F16H 57/0473; B60K 6/20; F16H 57/0412; F16H 57/048; F16N 2210/18; F16N 39/02; B60K 6/22; F16N 2210/04; F16N 2210/12; F16N 7/38

(57) ABSTRACT

An oil supply device that includes a first pump configured to discharge oil by being driven by power transferred along the power transfer path; a second pump configured to discharge the oil by being driven by a power source independent of the power transfer path; a first supply oil passage through which the oil discharged from the first pump is supplied to the transmission; and a second supply oil passage through which the oil discharged from the second pump is supplied to the friction engagement device.

### BACKGROUND

The present disclosure relates to an oil supply device.

In vehicular drive transmission device, for example, oil is generally used for controlling an engagement state of a friction engagement device and lubricating an intermesh portion between gears in a transmission. An oil supply device is provided in order to supply the oil to each portion of the vehicular drive transmission device. Japanese Patent Application Publication No. 2015-197146 (JP 2015-197146 A) discloses an example of the oil supply device.

The oil supply device of JP 2015-197146 A supplies oil to each portion of a vehicular drive transmission device [vehicular drive device] including a friction engagement device [clutch KO] and a transmission [transmission 33] in order from an internal combustion engine [internal combustion engine 2] side in a power transfer path connecting the internal combustion engine to wheels. The oil supply device mainly includes a first pump [mechanical oil pump 34] to be driven by power of the internal combustion engine, and a second pump [electric oil pump 35] to be driven by a power source [motor] independent of the power transfer path. The oil supply device further includes a first supply oil passage [lubrication oil passage 33L of the transmission 33 and oil passage on its upstream side] through which oil discharged from the first pump is supplied to the transmission, and a second supply oil passage [lubrication oil passage K0L of the clutch K0 and oil passage on its upstream side] through which oil discharged from the second pump is supplied to the friction engagement device.

In the oil supply device of JP 2015-197146 A, both the oil discharged from the first pump and the oil discharged from the second pump are supplied to a hydraulic pressure regulating valve [regulator valve 43]. A cooler configured to cool oil is provided on a downstream side of the hydraulic pressure regulating valve in the first supply oil passage. Therefore, the cooler cools only a part of the oil supplied to the hydraulic pressure regulating valve and discharged to the downstream side when a set hydraulic pressure [line pressure PL] is generated.

In this structure, the amount of oil to be actually supplied to the cooler depends on the magnitude of the set hydraulic pressure. For example, when the set hydraulic pressure is high and the amount of oil discharged to the downstream side is small, the oil cannot be cooled sufficiently. Particularly in a state in which the internal combustion engine is stopped and the first pump is not driven, the oil discharged from the second pump and supplied to the friction engagement device cannot be cooled sufficiently. Thus, there is a possibility that the friction engagement device cannot be cooled sufficiently.

### SUMMARY

An exemplary aspect of the disclosure attains an oil supply device in which oil can be cooled sufficiently irrespective of a traveling condition of a vehicle.

An oil supply device disclosed herein is an oil supply device to be provided in a vehicular drive transmission device including a friction engagement device and a transmission in order from an internal combustion engine side in a power transfer path connecting an internal combustion engine to a wheel. The oil supply device includes: a first pump configured to discharge oil by being driven by power transferred along the power transfer path; a second pump configured to discharge the oil by being driven by a power source independent of the power transfer path; a first supply oil passage through which the oil discharged from the first pump is supplied to the transmission; and a second supply oil passage through which the oil discharged from the second pump is supplied to the friction engagement device.

The first supply oil passage and the second supply oil passage have a common portion partially common to the first supply oil passage and the second supply oil passage. A cooler configured to cool the oil is provided in the common portion. The oil supply device includes a first selector valve configured to choose whether the oil discharged from the first pump flows into the common portion, and a second selector valve configured to choose whether the oil passing through the common portion flows into the transmission.

According to this structure, the cooler is provided in the common portion of the first supply oil passage and the second supply oil passage. Therefore, both the oil to be discharged from the first pump and supplied to the transmission and the oil to be discharged from the second pump and supplied to the friction engagement device can be cooled appropriately. At this time, a state in which the oil discharged from the first pump is cooled by the cooler and a state in which the oil discharged from the second pump is cooled by the cooler without causing the oil discharged from the first pump to flow into the common portion can be switched by appropriately switching a state of the first selector valve. Further, a state in which the oil cooled by the cooler flows into the transmission and a state in which the oil cooled by the cooler flows into the friction engagement device without the oil flowing into the transmission can be switched by appropriately switching a state of the second selector valve. Thus, the oil can appropriately be supplied to each portion of the vehicular drive transmission device while sufficiently cooling the oil irrespective of the traveling condition of the vehicle.

Further features and advantages of the technology disclosed herein will become more apparent from the following description of illustrative and non-limiting embodiments with reference to the drawings.

### BRIEF DESCRIPTION OF THE DRAWINGS

FIG. 1 is a schematic diagram illustrating the overall structure of a vehicular drive transmission device of a first embodiment.

FIG, 2 is a schematic diagram of an oil supply device.

FIG. 3 is a schematic diagram illustrating an example of how oil is supplied when a starting clutch is mildly cooled. FIG. 4 is a schematic diagram illustrating an example of how the oil is supplied when the starting clutch is intensively cooled.

FIG. 5 is a schematic diagram of an oil supply device of a second embodiment.

FIG. 6 is a schematic diagram illustrating an example of how oil supplied in a first state of a common spool valve.

FIG. 7 is a schematic diagram illustrating an example of how the oil is supplied in a second state of the common spool valve.

### DETAILED DESCRIPTION OF EMBODIMENTS

### First Embodiment

A first embodiment of an oil supply device is described with reference to the drawings. An oil supply device 1 of this embodiment is provided in a vehicular drive transmission device 9 and used in the vehicular drive transmission device 9.

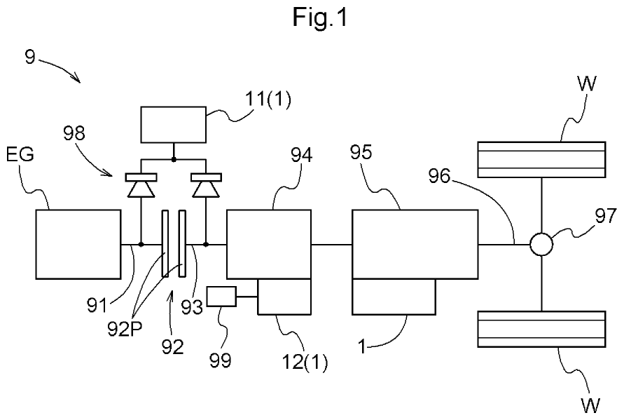

As illustrated in FIG. 1, the vehicular drive transmission device 9 is provided between an internal combustion engine EG and wheels W in various vehicles such as a hybrid vehicle. The vehicular drive transmission device 9 of this embodiment includes an input shaft 91, a starting clutch 92, an intermediate shaft 93, a rotating electrical machine 94, a transmission 95, an output shaft 96, and a differential gear device 97. The starting clutch 92, the rotating electrical machine 94, the transmission 95, and the differential gear device 97 are provided in the stated order from the internal combustion engine EG side in a power transfer path connecting the internal combustion engine EG to the wheels W. These components are housed in an unillustrated case (drive apparatus case).

The input shaft 91 is coupled to the internal combustion engine EG so as to rotate together with the internal combustion engine EG. For example, the starting clutch 92 is structured by a hydraulic-drive friction clutch. The starting clutch 92 is interposed between the input shaft 91 and the intermediate shaft 93. In an engagement state (direct engagement state in this case), the starting clutch 92 causes the input shaft 91 and the intermediate shaft 93 to rotate together. In a disengagement state, the starting clutch 92 interrupts power transfer between the input shaft 91 and the intermediate shaft 93. The starting clutch 92 may be brought into a slip engagement state in which friction plates 92P engage while slipping. In the slip engagement state, power is transferred from a higher rotation speed side to a lower rotation speed side while the input shaft 91 and the intermediate shaft 93 are rotating relative to each other. In this embodiment, the starting clutch 92 corresponds to a “friction engagement device”.

The intermediate shaft 93 is connected to the rotating electrical machine 94. The rotating electrical machine 94 functions as a drive source for the wheels W in cooperation with the internal combustion engine EG. The rotating electrical machine 94 includes a stator fixed to the case, and a rotor rotatably supported on a radially inner side of the stator. The rotor of the rotating electrical machine 94 is coupled to the intermediate shaft 93 so as to rotate together with the intermediate shaft 93.

The intermediate shaft 93 is coupled to an input side of the transmission 95 as an input member (shifting input member) of the transmission 95. For example, the transmission 95 may be a stepped automatic transmission configured to switch a plurality of shift speeds, or a stepless automatic transmission configured to change speed ratios steplessly. In the case of the stepped automatic transmission, it is appropriate that the transmission 95 be provided with, for example, a planetary gear mechanism and shifting engagement devices (clutches and brakes). The transmission 95 may have a single-axis structure or a multi-axis structure. In the case of the multi-axis structure, it is appropriate that the transmission 95 be provided with, for example, a counter gear mechanism. The transmission 95 shifts rotation of the intermediate shaft 93 serving as the shifting input member based on a speed ratio in response to the condition of the transmission 95, and outputs the rotation from the output shaft 96 serving also as an output member (shifting output member) of the transmission 95.

The output shaft 96 is coupled to the differential gear device 97, and also to the pair of right and left wheels W via the differential gear device 97 and a pair of right and left axles.

The vehicular drive transmission device 9 of this embodiment includes the oil supply device 1 including a first pump 11 and a second pump 12 in order to supply oil to each portion of the vehicular drive transmission device 9. For example, an internal or external gear pump or a vane pump may be used as the first pump 11 without particular limitation. For example, an internal or external gear pump or a vane pump may similarly be used as the second pump 12 without particular limitation.

The first pump 11 is a mechanical oil pump to be driven by power transferred along the power transfer path connecting the internal combustion engine EG to the wheels W. As illustrated in FIG. 1, the first pump 11 is coupled to the input shaft 91 and the intermediate shaft 93 via a power source switching mechanism 98. The power source switching mechanism 98 is structured by a pair of one-way clutches. In this example, one of the one-way clutches is interposed between the first pump 11 and the input shaft 91, and the other one-way clutch is interposed between the first pump 11 and the intermediate shaft 93. The first pump 11 discharges oil by being driven by a power source that is the input shaft 91 or the intermediate shaft 93 having a higher rotation speed.

The second pump 12 is an electric oil pump to be driven by power of an electric motor 99 independent of the power transfer path connecting the internal combustion engine EG to the wheels W. In this embodiment, the electric motor 99 corresponds to a “power source independent of the power transfer path”.

As illustrated in FIG. 2, the oil supply device 1 of this embodiment supplies oil discharged from at least one of the first pump 11 and the second pump 12 to the starting clutch 92, the transmission 95, the rotating electrical machine 94, and the like. The oil supply device 1 includes the first pump 11, the second pump 12, a first pressure regulating valve 21, a second pressure regulating valve 22, a first supply oil passage S1, and a second supply oil passage S2 as main constituent elements. The first supply oil passage S1 is an oil passage through which the oil discharged from the first pump 11 is supplied to the transmission 95 (specifically, gears included in the planetary gear mechanism and the counter gear mechanism). The first supply oil passage S1 includes a first reference pressure oil passage 41, a second reference pressure oil passage 42, and a lubrication oil passage 43. The second supply oil passage S2 is an oil passage through which the oil discharged from the second pump 12 is supplied to the starting clutch 92 (specifically, the friction plates 92P). The second supply oil passage S2 includes a subsidiary reference pressure oil passage 51 and a cooling/lubrication oil passage 52.

The first pump 11 sucks the oil (ATF; Automatic transmission fluid) from an oil pan provided at the bottom of the case, and discharges the oil while increasing the pressure to a predetermined pressure. One end of the first reference pressure oil passage 41 is connected to a discharge port of the first pump 11. The other end of the first reference pressure oil passage 41 is connected to an input port of the first pressure regulating valve 21.

The first pressure regulating valve 21 (primary regulator valve) is structured by a relief pressure reducing valve. The first pressure regulating valve 21 regulates a hydraulic pressure in the first reference pressure oil passage 41 located on an upstream side of the first pressure regulating valve 21 to be a line pressure PL by discharging, to a downstream side, a part of the oil discharged from the first pump 11 (or the second pump 12). In this embodiment, the first pressure regulating valve 21 corresponds to a “hydraulic pressure regulating valve”, and the line pressure PL corresponds to a “set hydraulic pressure”. The first pressure regulating valve 21 discharges (drains) surplus oil generated through pressure regulation from a first drain port and a second drain port. The oil from the first drain port is supplied to the second. pressure regulating valve 22 through the second reference pressure oil passage 42. The oil from the second drain port is returned to the first pump 11 (and the second pump 12) through a return oil passage (represented by “SUC” in FIG. 2).

The second pressure regulating valve 22 (secondary regulator valve) is structured by a relief pressure reducing valve. The second pressure regulating valve 22 discharges, to a downstream side, a part of the oil discharged from the first pump 11 (or the second pump 12) and then from the first drain port of the first pressure regulating valve 21. The second pressure regulating valve 22 regulates a hydraulic pressure in the second reference pressure oil passage 42 located on an upstream side of the second pressure regulating valve 22 to be a secondary pressure Psec lower than the line pressure PL. The second pressure regulating valve 22 discharges (drains) surplus oil generated through pressure regulation from a first drain port and a second drain port. The oil from the first drain port is supplied to the gears and the like in the transmission 95 through the lubrication oil passage 43. The oil from the second drain port is returned to the first pump 11 (and the second pump 12) through a return oil passage (represented by “SUC” in FIG. 2).

A cooler 25 and a first selector valve 31 are provided in the second reference pressure oil passage 42. The first selector valve 31 is provided on an upstream side (first pump 11 side) of the cooler 25. The first selector valve 31 is structured by an on-off valve. The first selector valve 31 switches an open state for permitting a flow of the oil in the second reference pressure oil passage 42 and a closed state for interrupting the flow of the oil. The cooler 25 reduces an oil temperature by cooling the oil flowing through the cooler 25 by heat exchange. A second selector valve 32 is provided in the lubrication oil passage 43. The second selector valve 32 is structured by a relay valve configured to switch source flow passages of the oil that flows toward the transmission 95. A “throttle” is provided in the lubrication oil passage 43 by an orifice 71.

One end of a first bypass oil passage 46 and one end of a second bypass oil passage 47 are connected to the second reference pressure oil passage 42. The one end of the first bypass oil passage 46 is connected to a third connection point c located on a downstream side of the first pressure regulating valve 21 and on an upstream side of the first selector valve 31. The other end of the first bypass oil passage 46 is connected to the lubrication oil passage 43 via the second selector valve 32. Thus, the first bypass oil passage 46 is connected in parallel to the first supply oil passage S1 while bypassing the first selector valve 31, the cooler 25, and the second pressure regulating valve 22. A “throttle” is provided in the first bypass oil passage 46 by an orifice 72.

The one end of the second bypass oil passage 47 is connected to a second connection point b located on the downstream side of the first pressure regulating valve 21 and on an upstream side of the first selector valve 31 and the third connection point c. The other end of the second bypass oil passage 47 is connected to a seventh connection point g located on a downstream side of the second selector valve 32. Thus, the second bypass oil passage 47 is connected in parallel to the first supply oil passage S1 while bypassing the first selector valve 31, the cooler 25, the second pressure regulating valve 22, and the second selector valve 32. A “throttle” is provided in the second bypass oil passage 47 by orifices 73. In this embodiment, the first bypass oil passage 46 and the second bypass oil passage 47 correspond to a “bypass oil passage”.

Similarly to the first pump 11, the second pump 12 sucks the oil from the oil pan at the bottom of the case, and discharges the oil while increasing the pressure to a predetermined pressure. One end of the subsidiary reference pressure oil passage 51 is connected to a discharge port of the second pump 12. The other end of the subsidiary reference pressure oil passage 51 is connected to the second reference pressure oil passage 42. In this embodiment, the subsidiary reference pressure oil passage 51 is connected to a fourth connection point d located on a downstream side of the first selector valve 31 and on an upstream side of the cooler 25 in the second reference pressure oil passage 42.

A third selector valve 33 is provided in the subsidiary reference pressure oil passage 51. The third selector valve 33 is structured by a relay valve configured to switch destination flow passages to which the oil discharged from the second pump 12 flows. The oil from a first output port of the third selector valve 33 is supplied to the second reference pressure oil passage 42 and the second pressure regulating valve 22 through the subsidiary reference pressure oil passage 51. One end of a connection oil passage 66 is connected to a second output port of the third selector valve 33. The other end of the connection oil passage 66 is connected to the first reference pressure oil passage 41. The connection oil passage 66 is connected to a first connection point a located on the upstream side of the first pressure regulating valve 21 in the first reference pressure oil passage 41. The oil from the second output port of the third selector valve 33 is supplied to the first reference pressure oil passage 41 and the first pressure regulating valve 21 through the connection oil passage 66.

The cooling/lubrication oil passage 52 that structures the second supply oil passage S2 in cooperation with the subsidiary reference pressure oil passage 51 is an oil passage through which the oil is supplied to the friction plates 92P of the starting clutch 92 in order to cool and lubricate the friction plates 92P. The cooling/lubrication oil passage 52 branches from the second reference pressure oil passage 42 at a sixth connection point f located on a downstream side of the cooler 25 and on the upstream side of the second pressure regulating valve 22 in the second reference pressure oil passage 42. A fourth selector valve 34 is provided in the cooling/lubrication oil passage 52. The fourth selector valve 34 is structured by an on-off valve. The fourth selector valve 34 switches an open state for permitting a flow of the oil in the cooling/lubrication oil passage 52 and a closed state for interrupting the flow of the oil. A “throttle” is provided in the cooling/lubrication oil passage 52 by an orifice 74.

As described above, in this embodiment, both the subsidiary reference pressure oil passage 51 and the cooling/lubrication oil passage 52 that structure the second supply oil passage S2 are connected to the second reference pressure oil passage 42 that structures the first supply oil passage S1. Further, the subsidiary reference pressure oil passage 51 is connected to the fourth connection point d located on the upstream side of the cooler 25 in the second reference pressure oil passage 42, and the cooling/lubrication oil passage 52 is connected to the sixth connection point f located on the downstream side of the cooler 25 in the second reference pressure oil passage 42. That is, in this embodiment, the first supply oil passage S1 and the second supply oil passage S2 have a common portion CP partially common to the first supply oil passage S1 and the second supply oil passage S2. The cooler 25 is provided in the common portion CP. In this example, the common portion CP of the first supply oil passage Si and the second supply oil passage S2 is a portion ranging from the fourth connection point d to the sixth connection point f in the second reference pressure oil passage 42.

Description is given below of relationships between the common portion CP and the first bypass oil passage 46, the second bypass oil passage 47, the connection oil passage 66, the first selector valve 31, the second selector valve 32, and the third selector valve 33 described above.

The first bypass oil passage 46 and the second bypass oil passage 47 are connected to the first supply oil passage S1 in parallel to the common portion CP while bypassing the common portion CR The second bypass oil passage 47 is provided so as to further bypass the first bypass oil passage 46. The connection oil passage 66 is connected to the first connection point a located on the upstream side of the first pressure regulating valve 21 in the first supply oil passage S1 and to a portion located on an upstream side of the common portion CP in the second supply oil passage S2 (third selector valve 33 provided in the subsidiary reference pressure oil passage 51).

The first selector valve 31 chooses whether the oil flowing from an upstream side of the common portion CP and the bypass oil passages 46 and 47 flows into the common portion CP on a downstream side or not. That is, the first selector valve 31 chooses whether the oil discharged from the first pump 11 flows into the common portion CR. In this embodiment, the oil flows at least into the second bypass oil passage 47 even if the oil flows into the common portion CR. Since the “throttle” is provided in the second bypass oil passage 47 by the orifices 73 as described above and a pressure loss increases, the amount of oil flowing through the second bypass oil passage 47 is smaller than the amount of oil toward the common portion CP in the state in which the oil flows into the common portion CP. Therefore, the first selector valve 31 chooses whether the oil flows toward the downstream side or not, thereby switching a main flow destination of the oil flowing from the upstream side of the common portion CP and the bypass oil passages 46 and 47 to the common portion CP or to the bypass oil passages 46 and 47.

That is, the first selector valve 31 switches a main flow destination of the oil flowing from the first drain port of the first pressure regulating valve 21 located on the upstream side of the bypass oil passages 46 and 47 to the common portion CP or to the bypass oil passages 46 and 47. In the open state, the first selector valve 31 guides the oil flowing after being discharged from the first pressure regulating valve 21 to the common portion CP (majority) and to the bypass oil passages 46 and 47 (minority). In the closed state, the first selector valve 31 guides the oil only to the bypass oil passages 46 and 47. This mode is herein included in the concept that “the flow destination of the oil flowing from the upstream side of the common portion and the bypass oil passage is switched to the common portion or to the bypass oil passage”. The first selector valve 31 may be structured such that the flow destination of the oil flowing from the upstream side of the common portion CP and the bypass oil passages 46 and 47 is switched exclusively to the common portion CP or to the bypass oil passages 46 and 47.

The second selector valve 32 chooses whether the oil passing through the common portion flows into the transmission. More specifically, the second selector valve 32 chooses whether the oil passing through the common portion CP is supplied to the transmission 95 on the downstream side or is drained. In this embodiment, the oil is supplied at least to the starting clutch 92 through a cooling oil passage 56 and a communication oil passage 58 described later even if the oil flows into the transmission 95. A “throttle” is provided in the communication oil passage 58 by orifices 76, and a pressure loss increases. Thus, the amount of oil supplied to the starting clutch 92 through the cooling oil passage 56 and the communication oil passage 58 is smaller than the amount of oil supplied to the transmission 95 in the state in which the oil is supplied to the transmission 95. Therefore, the second selector valve 32 chooses whether the oil flows toward the downstream side or is drained, thereby switching a main flow destination of the oil passing through the common portion CP to the transmission 95 or to the starting clutch 92.

That is, the second selector valve 32 switches a main flow destination of the oil cooled by the cooler 25 provided in the common portion CP to the gears and the like in the transmission 95 or to the friction plates 92P of the starting clutch 92. In a first state, the second selector valve 32 guides both the oil flowing from the cooler 25 and the oil flowing from the first bypass oil passage 46 to the transmission 95. In a second state, the second selector valve 32 discharges the oil flowing from the cooler 25, and interrupts the flow of the oil in the first bypass oil passage 46. Thus, in the first state, the second selector valve 32 guides the oil flowing from the cooler 25 to the transmission 95 (majority) together with the oil flowing from the first bypass oil passage 46 and to the starting clutch 92 (friction plates 92P) (minority). In the second state, the second selector valve 32 guides the oil to the starting clutch 92 (friction plates 92P) without guiding the oil to the transmission 95. This mode is herein included in the concept that “the flow destination of the oil passing through the common portion is switched to the transmission or to the friction engagement device”. The second selector valve 32 may be structured such that the flow destination of the oil passing through the common portion CP is switched exclusively to the transmission 95 or to the starting clutch 92.

The third selector valve 33 switches a flow destination of the oil discharged from the second pump 12 to the common portion CP or to the connection oil passage 66. The third selector valve 33 switches the flow destination of the oil discharged from the second pump 12 to the cooler 25 or to the input port of the first pressure regulating valve 21. In a first state, the third selector valve 33 guides the oil discharged from the second pump 12 to the cooler 25. In a second state, the third selector valve 33 guides the oil to the first pressure regulating valve 21. The oil supplied to the input port of the first pressure regulating valve 21 may be supplied to the cooler 25 from the first drain port of the first pressure regulating valve 21.

The oil supply device 1 of this embodiment further includes a third supply oil passage S3 and a fourth supply oil passage S4. The third supply oil passage S3 is an oil passage branching from a fifth connection point e located on the downstream side of the cooler 25 in the second supply oil passage S2 and structured such that the oil passing through the cooler 25 is supplied to the rotating electrical machine 94. The third supply oil passage S3 includes the cooling oil passage 56. In the cooling oil passage 56, the oil is supplied to stator coils, permanent magnets, and the like of the rotating electrical machine 94 in order to cool the stator coils, the permanent magnets, and the like. As a method for supplying the oil to the rotating electrical machine 94, various methods may be employed, such as a method in which the oil is supplied by dripping down from above the stator (supplied from the top), or a method in which the oil is caused to flow radially outward from an oil passage formed in a rotor shaft (supplied from the center of the shaft). A “throttle” is provided in the cooling oil passage 56 by an orifice 75.

In this embodiment, the communication oil passage 58 connecting the cooling oil passage 56 to the cooling/lubrication oil passage 52 through which the oil is supplied to the friction plates 92P of the starting clutch 92 is further provided over the cooling oil passage 56 and the cooling/lubrication oil passage 52. The “throttle” is also provided in the communication oil passage 58 by the orifices 76.

The fourth supply oil passage S4 is an oil passage through which the oil whose pressure is regulated to be the line pressure PL by the first pressure regulating valve 21 is supplied to the starting clutch 92. The fourth supply oil passage S4 includes an engagement control oil passage 61. In the engagement control oil passage 61, the oil having the line pressure PL is supplied to a hydraulic servo mechanism 92S of the starting clutch 92 in order to control the engagement state (direct engagement state/slip engagement state/disengagement state) of the starting clutch 92. The hydraulic servo mechanism 92S may include, for example, a linear solenoid valve configured to further regulate a hydraulic pressure by using the line pressure PL as an original pressure. The engagement control oil passage 61 is connected to the first connection point a that is a portion connecting the first reference pressure oil passage 41 to the connection oil passage 66.

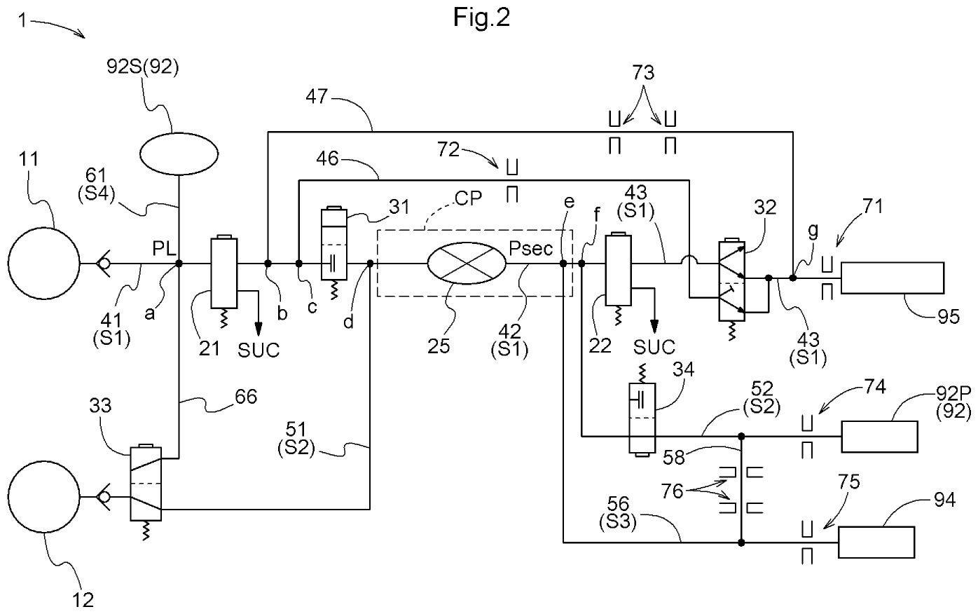

For example, when the vehicle steadily travels at least by a torque of the internal combustion engine EU the friction plates 92P of the starting clutch 92 are brought into press contact with each other so as to rotate together without a slip. Therefore, the heat generation amount is small, and the need for cooling is not very strong. In this case, as illustrated in FIG. 3, the first selector valve 31 is set in the open state, the second selector valve 32 is set in the first state, the third selector valve 33 is set in the second state, and the fourth selector valve 34 is set in the closed state. Then, the oil discharged from the first pump 11 and the oil discharged from the second pump 12 are supplied to the first pressure regulating valve 21 while merging with each other, thereby generating the line pressure PL. The oil having the line pressure PL is supplied to the hydraulic servo mechanism 92S of the starting clutch 92, and the starting clutch 92 is kept in the direct engagement state.

A part of the oil discharged from the first pressure regulating valve 21 for pressure regulation is cooled by the cooler 25, and the other part flows through the bypass oil passages 46 and 47. Those parts of the oil are supplied to the transmission 95 after merging with each other, thereby lubricating the gears and the like. A part of the oil cooled by the cooler 25 is supplied to the rotating electrical machine 94 to mainly cool the stator coils, the permanent magnets, and the like, and a part of the supplied oil is also supplied to the starting clutch 92 to cool the friction plates 92P. While the vehicle is steadily traveling, the line pressure PL is relatively high, and the amount of oil discharged from the first pressure regulating valve 21 is not very large, but the oil suffices if the lubrication of the gears in the transmission 95 and the cooling of the stator coils and the like of the rotating electrical machine 94 can be performed appropriately. If the amount of oil discharged from the first pump 11 is sufficiently large in the case illustrated in FIG. 3, the second pump 12 may be stopped and the oil may be supplied to each portion from the first pump 11 alone.

For example, when the vehicle is started at least by the torque of the internal combustion engine EG, the starting clutch 92 may be brought into the slip engagement state in order to smooth out differential rotation between a synchronization rotation speed depending on a vehicle speed and a minimum rotation speed for preventing a stall of the internal combustion engine EG. In this case, the starting clutch 92 transfers the torque of the internal combustion engine EG while the friction plates 92P are slipping. Therefore, the heat generation amount increases, and the need for cooling is strong. In this case, as illustrated in FIG. 4, the first selector valve 31 is set in the closed state, the second selector valve 32 is set in the second state, the third selector valve 33 is set in the first state, and the fourth selector valve 34 is set in the open state. Then, only the oil discharged from the first pump 11 is supplied to the first pressure regulating valve 21, and the oil discharged from the first pressure regulating valve 21 is supplied to the transmission 95 through the second bypass oil passage 47, thereby lubricating the gears and the like.

The oil discharged from the second pump 12 is supplied to the cooler 25. In this case, all the oil discharged from the second pump 12 is supplied to the cooler 25. Then, a large amount of oil cooled by the cooler 25 is supplied to the starting clutch 92 and the rotating electrical machine 94 to cool the. friction plates 92P, the stator coils, and the like. When the vehicle is started, the heat generation amount may increase because the starting clutch 92 is brought into the slip engagement state, but all the oil discharged from the second pump 12 is directly cooled by the cooler 25 and is supplied to the friction plates 92P, whereby the friction plates 92P that generate heat can be cooled sufficiently. Thus, overheating of the starting clutch 92 can be suppressed. When the vehicle is started., a certain magnitude of the line pressure PL is necessary, and the vehicle speed and the rotation speed of the internal combustion engine EG are relatively low. Therefore, the amount of oil discharged from the first pressure regulating valve 21 is not very large. However, the oil suffices if the gears in the transmission 95 can be lubricated appropriately.

### Second Embodiment

A second embodiment of the oil supply device is described with reference to the drawings. In this embodiment, the specific structures of the selector valve and the bypass oil passage differ from those in the first embodiment. The oil supply device of this embodiment is described below focusing on the differences from the first embodiment. The matters that are not particularly described are similar to those in the first embodiment, and the same reference symbols are assigned to omit detailed. description.

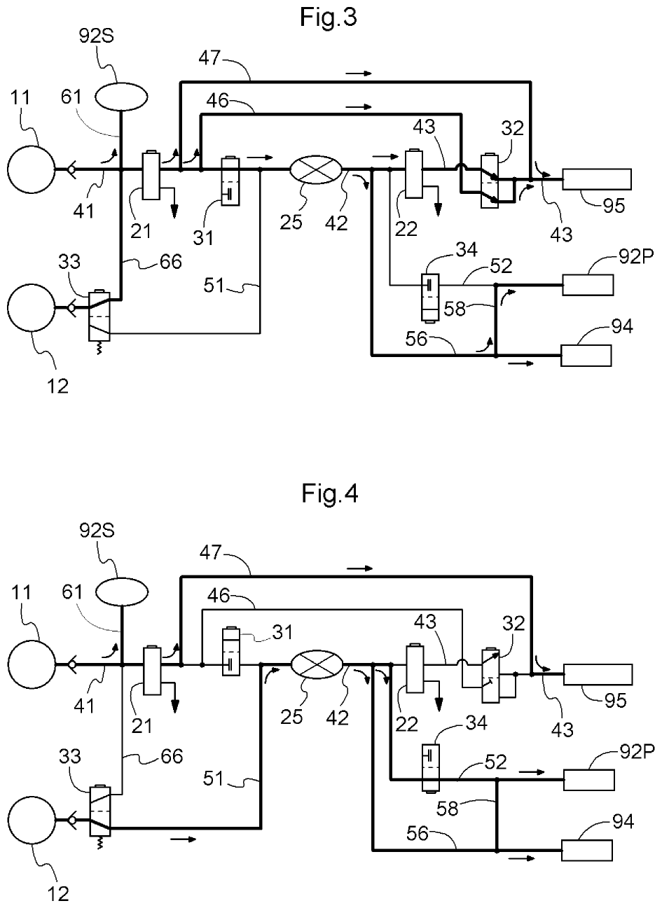

As illustrated in FIG. 5, the oil supply device 1 of this embodiment supplies the oil discharged from at least one of the first pump 11 and the second pump 12 to the starting clutch 92, the transmission 95, the rotating electrical machine 94, and the like. The oil supply device 1 includes the first pump 11, the second pump 12, the first pressure regulating valve 21, a common spool valve 36, the first supply oil passage S1, and the second supply oil passage 52 as main constituent elements. The first supply oil passage S1 includes the first reference pressure oil passage 41, a heat exchange oil passage 44, and the lubrication oil passage 43. The second supply oil passage 52 includes the subsidiary reference pressure oil passage 51 and the cooling/lubrication oil passage 52.

The one end of the first reference pressure oil passage 41 is connected to the discharge port of the first pump 11. The other end of the first reference pressure oil passage 41 is connected to the input port of the first pressure regulating valve 21. The first pressure regulating valve 21 regulates the hydraulic pressure in the first reference pressure oil passage 41 located on the upstream side of the first pressure regulating valve 21 to be the line pressure PL by discharging, to the downstream side, a part of the oil discharged from the first pump 11 (or the second pump 12).

In this embodiment, the second pressure regulating valve 22 configured to generate the secondary pressure Psec from the line pressure PL is not provided. One end of the heat exchange oil passage 44 is connected to the first drain port of the first pressure regulating valve 21. The oil from the first drain port of the first pressure regulating valve 21 is supplied to the gears and the like in the transmission 95 through the heat exchange oil passage 44 and the lubrication oil passage 43.

The cooler 25 and the common spool valve 36 are provided in the heat exchange oil passage 44. The common spool valve 36 is provided on the upstream side (first pump 11 side) of the cooler 25. The common spool valve 36 is structured by a spool valve having a spool. An upstream portion of the heat exchange oil passage 44 is connected to a third input port 36c of the common spool valve 36, and a downstream portion of the heat exchange oil passage 44 is connected to a third output port 36g and a first input port 36a of the common spool valve 36. The common spool valve 36 is configured to switch a first state and a second state depending on the position of the spool. The switching of the two states (first state/second state) is described later. The cooler 25 reduces the oil temperature by cooling the oil flowing through the cooler 25 by heat exchange.

A single bypass oil passage 48 is connected to the heat exchange oil passage 44. One end of the bypass oil passage 48 is connected to the downstream side of the first pressure regulating valve 21 and to an upstream side of the common spool valve 36. The other end of the bypass oil passage 48 is connected to a second input port 36b of the common spool valve 36. The bypass oil passage 48 is connected to the lubrication oil passage 43 via the common spool valve 36. Thus, the bypass oil passage 48 is connected to the lubrication oil passage 43 while bypassing the cooler 25. A “throttle” is provided in the bypass oil passage 48 by an orifice 77.

One end of the lubrication oil passage 43 is connected to a second output port 36f of the common spool valve 36. The other end of the lubrication oil passage 43 extends to the gears and the like in the transmission 95. The “throttle” is provided in the lubrication oil passage 43 by the orifice 71.

The one end of the subsidiary reference pressure oil passage 51 is connected to the discharge port of the second pump 12. The other end of the subsidiary reference pressure oil passage 51 is connected to a fourth input port 36d of the common spool valve 36. The subsidiary reference pressure oil passage 51 is connected alternatively to the heat exchange oil passage 44 or to the connection oil passage 66 via the common spool valve 36. The one end of the connection oil passage 66 is connected to a fourth output port 36h of the common spool valve 36. The other end of the connection oil passage 66 is connected to the upstream side of the first pressure regulating valve 21 in the first reference pressure oil passage 41.

One end of the cooling/lubrication oil passage 52 is connected to a first output port 36e of the common spool valve 36. The other end of the cooling/lubrication oil passage 52 extends to the friction plates 92P of the starting clutch 92. The “throttle” is provided in the cooling/lubrication oil passage 52 by the orifice 74.

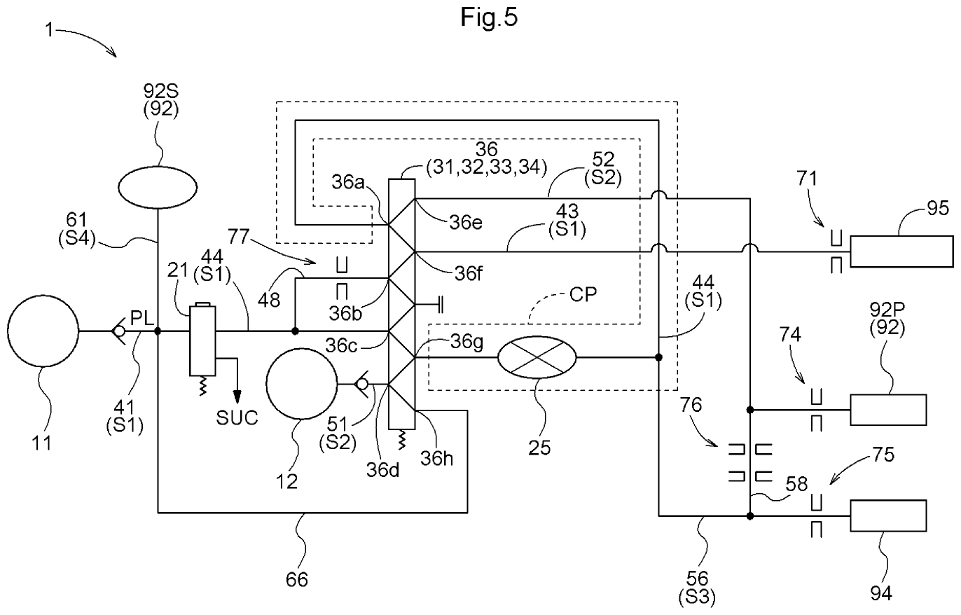

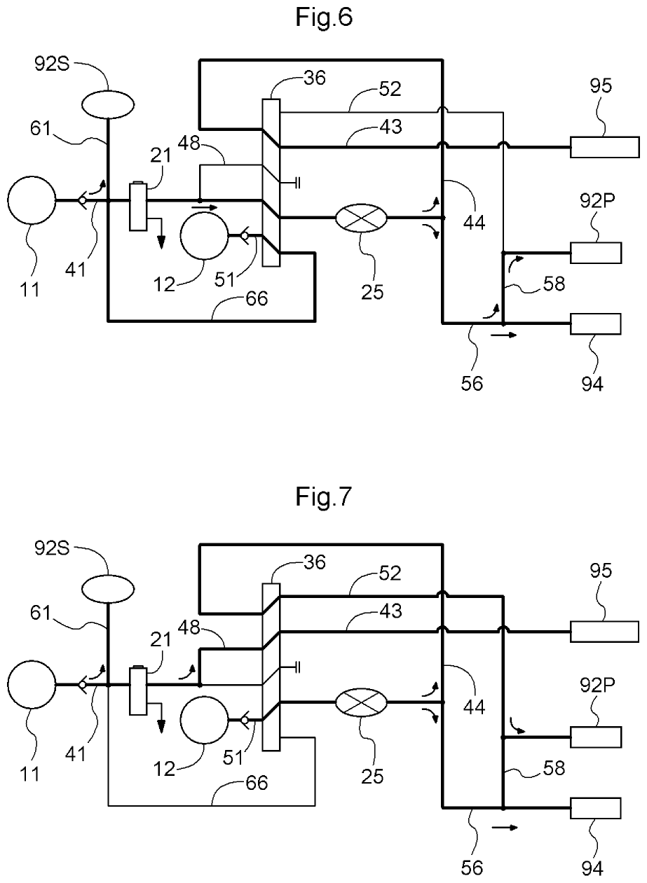

As described above, the common spool valve 36 is configured to switch the first state and the second state depending on the position of the spool. In the first state, the first input port 36a communicates with the second output port 36f, the third input port 36c communicates with the third output port 36g, and the fourth input port 36d communicates with the fourth output port 36h (see FIG. 6 as well). In the second state, the first input port 36a communicates with the first output port 36e, the second input port 36b communicates with the second output port 36f, and the fourth input port 36d communicates with the third output port 36g (see FIG. 7 as well).

Since the fourth input port 36d communicates with the fourth output port 36h in the first state as illustrated in FIG. 6, the subsidiary reference pressure oil passage 51 communicates with the connection oil passage 66. Thus, the oil discharged from the second pump 12 is supplied for generation of the line pressure PL together with the oil discharged from the first pump 11. Since the third input port 36c communicates with the third output port 36g, the upstream portion and the downstream portion of the heat exchange oil passage 44 communicate with each other. Thus, the oil discharged from the first pump 11 and the second pump 12 and from the first drain port of the first pressure regulating valve 21 when the line pressure PL is generated is supplied to the cooler 25 for cooling. Since the first input port 36a communicates with the second output port 36f, the heat exchange oil passage 44 communicates with the lubrication oil passage 43. Thus, the oil cooled by the cooler 25 as described above is supplied to the gears and the like in the transmission 95. At this time, the oil cooled by the cooler 25 is also supplied to the friction plates 92P of the starting clutch 92 and to the stator coils and the like of the rotating electrical machine 94.

Since the fourth input port 36d does not communicate with the fourth output port 36h in the second state as illustrated in FIG. 7, the first pump 11 and the second pump 12 supply the oil independently of each other. Since the second input port 36b communicates with the second output port 36f, the bypass oil passage 48 communicates with the lubrication oil passage 43. Thus, the oil discharged from the first pump 11 and from the first drain port of the first pressure regulating valve 21 when the line pressure PL is generated is supplied to the gears and the like in the transmission 95 without passing through the cooler 25. Since the fourth input port 36d communicates with the third output port 36g, the subsidiary reference pressure oil passage 51 communicates with the heat exchange oil passage 44. Since the first input port 36a communicates with the first output port 36e, the heat exchange oil passage 44 communicates with the cooling/lubrication oil passage 52. Thus, the oil discharged from the second pump 12 is cooled by the cooler 25 and then supplied to the friction plates 92P of the starting clutch 92. At this time, the oil cooled by the cooler 25 is also supplied to the stator coils and the like of the rotating electrical machine 94.

As described above, in this embodiment, the common spool valve 36 switches the first state and the second state to choose whether the oil discharged from the first pump 11 flows into the common portion CP (cooler 25) (function of the first selector valve 31 in the first embodiment). At this time, the common spool valve 36 chooses whether the oil passing through the common portion CP (cooler 25) flows into the gears and the like in the transmission 95 (function of the second selector valve 32 in the first embodiment). In addition, the common spool valve 36 chooses whether the oil passing through the common portion CP (cooler 25) flows into the friction plates 92P of the starting clutch 92 without passing through the communication oil passage 58 (function of the fourth selector valve 34 in the first embodiment). At this time, the common spool valve 36 switches the flow destination of the oil discharged from the second pump 12 to the common portion CP (cooler 25) or to the connection oil passage 66 (function of the third selector valve 33 in the first embodiment). That is, the common spool valve 36 of this embodiment is an integrated valve having all the functions of the first selector valve 31, the second selector valve 32, the third selector valve 33, and the fourth selector valve 34 described in the first embodiment. Therefore, in this embodiment, the common spool valve 36 corresponds to the “first selector valve”, the “second selector valve”, and the “third selector valve”.

### Other Embodiments

(1) In the first embodiment described above, description is given of the exemplary structure in which the second selector valve 32 is configured to change stepwise the amount of oil that flows toward the transmission 95. However, the present disclosure is not limited to this structure. The second selector valve 32 may be structured such that the amount of oil to be caused to flow toward the transmission 95 can be changed continuously; including “zero”.

(2) In the first embodiment described above, description is given of the example in which the third selector valve 33 is structured by the relay valve provided in the subsidiary reference pressure oil passage 51. However, the present disclosure is not limited to this structure. For example, the third selector valve 33 may be structured by an on-off valve provided in the connection oil passage 66.

(3) In the first embodiment described above, description is given of the example in which the first selector valve 31, the second selector valve 32, the third selector valve 33, and the fourth selector valve 34 are structured as independent selector valves. In the second embodiment, description is given of the example in which all the selector valves are structured by the integrated valve (common spool valve 36). However, the present disclosure is not limited to this structure. For example, only the first selector valve 31 and the second selector valve 32 may be structured by the integrated valve (for example, the common spool valve). Alternatively, only the first selector valve 31, the second selector valve 32, and the third selector valve 33 may be structured by the integrated valve. In addition, any combination of two or three selector valves out of the first selector valve 31, the second selector valve 32, the third selector valve 33, and the fourth selector valve 34 may be structured by the integrated valve.

(4) In the first embodiment described above, description is given of the exemplary structure in which the oil supply device 1 is provided with the second pressure regulating valve 22 configured to generate the secondary pressure Psec. However, the present disclosure is not limited to this structure. As in the second embodiment, the second pressure regulating valve 22 need not essentially be provided.

(5) In the embodiments described above, description is given of the exemplary structure in which the first pump 11 is driven by the input shaft 91 or the intermediate shaft 93 having a higher rotation speed. However, the present disclosure is not limited to this structure. For example, the first pump 11 may be driven solely by the input shaft 91 or solely by the intermediate shaft 93. Alternatively, the first pump 11 may be driven solely by, for example, the output shaft 96.

(6) In the embodiments described above, description is given of the exemplary oil supply device 1 for use in the vehicular drive transmission device 9 in which the dedicated starting clutch 92 is provided between the input shaft 91 and the intermediate shaft 93. However, the present disclosure is not limited to this structure. For example, the oil supply device 1 may be used in a vehicular drive transmission device 9 in which a hydraulic coupling (such as a torque converter or a fluid coupling) having a lock-up clutch is provided between the input shaft 91 and the intermediate shaft 93. In this structure, the lock-up clutch corresponds to the “friction engagement device”.

(7) In the embodiments described above, description is given of the exemplary structure in which the vehicular drive transmission device 9 provided with the oil supply device 1 is a drive transfer apparatus for a hybrid vehicle. However, the present disclosure is not limited to this structure. The oil supply device 1 may be used in a drive transfer apparatus for a so-called engine vehicle in which the rotating electrical machine 94 is not provided.

(8) The structures disclosed in the embodiments described above (including the embodiments described above and the other embodiments; the same applies hereinafter) are also applicable in combination with the structures disclosed in the other embodiments without causing any contradiction. Regarding other structures as well, the embodiments disclosed herein are illustrative in all respects. Thus, modifications may be made as appropriate without departing from the spirit of the disclosure.

### SUMMARY OF EMBODIMENTS

To summarize the above, the oil supply device disclosed herein preferably has the following structures.

The oil supply device (1) is provided in the vehicular drive transmission device (9) including the friction engagement device (92) and the transmission (95) in order from the internal combustion engine (EG) side in the power transfer path connecting the internal combustion engine (EG) to the wheels (W). The oil supply device (1) includes:
the first pump (11) configured to discharge the oil by being driven by the power transferred along the power transfer path;
the second pump (12) configured to discharge the oil by being driven by the power source (99) independent of the power transfer path;
the first supply oil passage (S1) through which the oil discharged from the first pump (11) is supplied to the transmission (95); and
the second supply oil passage (S2) through which the oil discharged from the second pump (12) is supplied to the friction engagement device (92).

The first supply oil passage (S1) and the second supply oil passage (S2) have the common portion (CP) partially common to the first supply oil passage (S1) and the second supply oil passage (S2).

The cooler (25) configured to cool the oil is provided in the common. portion (CP).

The oil supply device (1) includes the first selector valve (31) configured to choose whether the oil discharged from the first pump (11) flows into the common portion (CP), and the second selector valve (32) configured to choose whether the oil passing through the common portion flows into the transmission (95).

According to this structure, the cooler (25) is provided in the common portion (CP) of the first supply oil passage (S1) and the second supply oil passage (S2). Therefore, both the oil to be discharged from the first pump (11) and supplied to the transmission (95) and the oil to be discharged from the second pump (12) and supplied to the friction engagement device (92) can be cooled appropriately. At this time, the state in which the oil discharged from the first pump (11) is cooled by the cooler (25) and the state in which the oil discharged from the second pump (12) is cooled by the cooler (25) without causing the oil discharged from the first pump (11) to flow into the common portion (CP) can be switched by appropriately switching the state of the first selector valve (31). Further, the state in which the oil cooled by the cooler (25) flows into the transmission (95) and the state in which the oil cooled by the cooler (25) flows into the friction engagement device (92) without the oil flowing into the transmission (95) can be switched by appropriately switching the state of the second selector valve (32). Thus, the oil can appropriately be supplied to each portion of the vehicular drive transmission device (9) while sufficiently cooling the oil irrespective of the traveling condition of the vehicle.

As one aspect, the following structure is preferable.

The bypass oil passage (46, 47, 48) that bypasses the common portion (CP) is connected to the first supply oil passage (S1).

The first selector valve (31) is configured to choose whether the oil discharged from the first pump (11) flows into the common portion (CP) to switch the flow destination of the oil flowing from the upstream side of the common portion (CP) and the bypass passage (46, 47, 48) to the common portion (CP) or to the bypass oil passage (46, 47, 48).

According to this structure, when the oil discharged from the first pump (11) is not caused to flow into the common portion (CP), the oil can he caused to flow into the bypass oil passage (46, 47, 48). Thus, it is possible to switch the state in which the oil discharged from the first pump (11) is supplied to the transmission (95) while passing through the bypass oil passage (46, 47, 48) (that is, without cooling the oil) and the state in which the oil discharged from the first pump (11) is cooled by the cooler (25) and supplied to the transmission (95).

As one aspect, the following structure is preferable.

The hydraulic pressure regulating valve (21) configured to regulate the hydraulic pressure on the upstream side to be the set hydraulic pressure (PL) by discharging, to the downstream side, a part of the oil discharged from the first pump (11) is provided on the upstream side of the connection point between the first supply oil passage (S1) and the bypass oil passage (46, 47, 48),

According to this structure, the oil discharged to the downstream side when the hydraulic pressure regulating valve (21) regulates the hydraulic pressure on its upstream side to be the set hydraulic pressure (PL) is supplied to the cooler (25) provided in the common portion (CP) located on the downstream side of the bypass oil passage (46, 47, 48). Therefore, the amount of oil cooled by the cooler (25) is relatively small, and depends on the magnitude of the set hydraulic pressure (PL). Thus, there is a relatively strong possibility that the oil cannot be cooled sufficiently. In this respect, according to the technology disclosed herein, the oil discharged from the second pump (12) can directly be supplied to the cooler (25) without passing through the hydraulic pressure regulating valve (21). Thus, a large amount of oil can be supplied to the cooler (25) and cooled sufficiently irrespective of the magnitude of the set hydraulic pressure (PL).

As one aspect, it is preferable that the oil supply device (1) further include:
the connection oil passage (66) connecting the portion located on the upstream side of the hydraulic pressure regulating valve (21) in the first supply oil passage (S1) to the portion located on the upstream. side of the common portion (CP) in the second supply oil passage (52); and
the third selector valve (33) configured to switch the flow destination of the oil discharged from the second pump (12) to the common portion (CP) or to the connection oil passage (66).

According to this structure, the state in which the oil discharged from the second pump (12) is directly supplied to the cooler (25) without passing through the hydraulic pressure regulating valve (21) and the state in which the oil discharged from the second pump (12) is supplied to the hydraulic pressure regulating valve (21) can be switched by appropriately switching the state of the third selector valve (33). In the latter state, for example, it is possible to generate the set hydraulic pressure (PL) even in a state in which the first pump (11) is not driven, and to avoid a decrease in fuel efficiency of the vehicle due to excessive supply of cold oil to the friction engagement device (92) in a situation in which the need for cooling of the friction engagement device (92) is not very strong.

As one aspect, the following structure is preferable.

The second selector valve (32) is configured to choose whether the oil passing through the common portion (CP) flows into the transmission (95) to switch the flow destination of the oil passing through the common portion (CP) to the transmission (95) or to the friction engagement device (92).

According to this structure, when the oil passing through the common portion (CP) is not caused to flow into the transmission (95), the oil can be caused to flow into the friction engagement device (92). Thus, it is possible to switch the state in which the oil cooled by the cooler (25) is supplied to the transmission (95) and the state in which the oil is supplied to the friction engagement device (92). Accordingly, both the transmission (95) and the friction engagement device (92) can be cooled sufficiently by the oil sufficiently cooled by the cooler (25).

As one aspect, the following structure is preferable.

The vehicular drive transmission device (9) further includes the rotating electrical machine (94) provided in the power transfer path and configured to drive the wheels (W).

The oil supply device (1) further includes the third supply oil passage (S3) branching from the portion located on the downstream side of the cooler (25) in the second supply oil passage (S2) and structured such that the oil passing through the cooler (25) is supplied to the rotating electrical machine (94).

According to this structure, the rotating electrical machine (94) together with the friction engagement device (92) can be cooled sufficiently by the oil sufficiently cooled by the cooler (25).

As one aspect, the following structure is preferable.

The first selector valve (31) and the second selector valve (32) are structured by the common spool valve (36) having the common spool.

According to this structure, costs can be reduced by reducing the number of components as compared to the structure in which the first selector valve (31) and the second selector valve (32) are provided independently of each other.

As one aspect, the following structure is preferable.

The first selector valve (31), the second selector valve (32), and the third selector valve (33) are structured by the common spool valve (36) having the common spool.

According to this structure, costs can be reduced by reducing the number of components as compared to the structure in which the first selector valve (31), the second selector valve (32), and the third selector valve (33) are provided independently of each other.

As one aspect, the following structure is preferable.

The common spool valve (36) is configured to switch the first state and the second state depending on the position of the spool.

In the first state, the oil discharged from the first pump (11) is cooled by the cooler and then supplied to the transmission (95), and the oil discharged from the second pump (12) is supplied to the connection oil passage (66).

In the second state, the oil discharged from the first pump (11) is supplied to the transmission (95) through the bypass oil passage (48), and the oil discharged from the second pump (12) is cooled by the cooler (25) and then supplied to the friction engagement device (92).

According to this structure, the state in which the oil discharged from the first pump (11) and the second pump (12) is cooled and then supplied to the transmission (95) and the state in which the oil discharged from the first pump (11) is supplied to the transmission (95) without cooling the oil and the oil discharged from the second pump (12) is cooled and then supplied to the friction engagement device (92) can easily be switched by simply switching the two positions of the spool of the common spool valve (36).

The oil supply device (1) is provided in the vehicular drive transmission device (9) including the friction engagement device (92) and the transmission (95) in order from the internal combustion engine (EG) side in the power transfer path connecting the internal combustion engine (EG) to the wheels (W). The oil supply device (1) includes:
the first pump (11) configured to discharge the oil by being driven by the power transferred along the power transfer path;
the second pump (12) configured to discharge the oil by being driven by the power source (99) independent of the power transfer path;
the first supply oil passage (S1) through which the oil discharged from the first pump (11) is supplied to the transmission (95); and
the second supply oil passage (S2) through which the oil discharged from the second pump (12) is supplied to the friction engagement device (92).

The first supply oil passage (S1) and the second supply oil passage (S2) have the common portion (CP) partially common to the first supply oil passage (S1) and the second supply oil passage (S2).

The cooler (25) configured to cool the oil is provided in the common portion (CP), and the bypass oil passage (46, 47) that bypasses the common portion (CP) is connected to the first supply oil passage (S1) in parallel to the common portion (CP).

The oil supply device (1) includes the first selector valve (31) configured to switch the flow destination of the oil flowing from the upstream side of the common portion (CP) and the bypass oil passage (46, 47) to the common portion (CP) or to the bypass oil passage (46, 47), and the second selector valve (32) configured to switch the flow destination of the oil passing through the common portion (CP) to the transmission (95) or to the friction engagement device (92).

According to this structure, the cooler (25) is provided in the common portion (CP) of the first supply oil passage (S1) and the second supply oil passage (S2).

Therefore, both the oil to be discharged from the first pump (11) and supplied to the transmission (95) and the oil to be discharged from the second pump (12) and supplied to the friction engagement device (92) can be cooled appropriately. At this time, the state in which the oil discharged from the second pump (12) is cooled by the cooler (25) and supplied to the friction engagement device (92) and the oil discharged from the first pump (11) is supplied to the transmission (95) via the bypass oil passage (46, 47) and the state in which the oil discharged from the first pump (11) is cooled by the cooler (25) and supplied to the transmission (95) can be switched by appropriately switching the states of the first selector valve (31) and the second selector valve (32). Thus, the oil can appropriately be supplied to each portion of the vehicular drive transmission device (9) while sufficiently cooling the oil irrespective of the traveling condition of the vehicle. in particular, the friction engagement device (92) can be cooled appropriately and sufficiently.

The oil supply device disclosed herein suffices if at least one of the effects described above can be attained.

1-9. (canceled)

10. An oil supply device to be provided in a vehicular drive transmission device including a friction engagement device and a transmission in order from an internal combustion engine side in a power transfer path connecting an internal combustion engine to a wheel, the oil supply device comprising:
a first pump configured to discharge oil by being driven by power transferred along the power transfer path;
a second pump configured to discharge the oil by being driven by a power source independent of the power transfer path;
a first supply oil passage through which the oil discharged from the first pump is supplied to the transmission; and
a second supply oil passage through which the oil discharged from the second pump is supplied to the friction engagement device, wherein:
the first supply oil passage and the second supply oil passage have a common portion partially common to the first supply oil passage and the second supply oil passage,
a cooler configured to cool the oil is provided in the common portion, and
the oil supply device includes a first selector valve configured to choose whether the oil discharged from the first pump flows into the common portion, and a second selector valve configured to choose whether the oil passing through the common portion flows into the transmission.

11. The oil supply device according to claim 10, wherein:
a bypass oil passage that bypasses the common portion is connected to the first supply oil passage, and
the first selector valve is configured to choose whether the oil discharged from the first pump flows into the common portion to switch a flow destination of the oil flowing from an upstream side of the common portion and the bypass oil passage to the common portion or to the bypass oil passage.

12. The oil supply device according to claim 11, wherein a hydraulic pressure regulating valve configured to regulate a hydraulic pressure on an upstream side to be a set hydraulic pressure by discharging, to a downstream side, a part of the oil discharged from the first pump is provided on an upstream side of a connection point between the first supply oil passage and the bypass oil passage.

13. The oil supply device according to claim 12, further comprising:
a connection oil passage connecting a portion located on an upstream side of the hydraulic pressure regulating valve in the first supply oil passage to a portion located on an upstream side of the common portion in the second supply oil passage; and
a third selector valve configured to switch a flow destination of the oil discharged from the second pump to the common portion or to the connection oil passage.

14. The oil supply device according to claim 13, wherein the second selector valve is configured to choose whether the oil passing through the common portion flows into the transmission to switch a flow destination of the oil passing through the common portion to the transmission or to the friction engagement device.

15. The oil supply device according to claim 14, wherein:
the vehicular drive transmission device further includes a rotating electrical machine provided in the power transfer path and configured to drive the wheel, and
the oil supply device further includes a third supply oil passage branching from a portion located on a downstream side of the cooler in the second supply oil passage and structured such that the oil passing through the cooler is supplied to the rotating electrical machine.

16. The oil supply device according to claim 15, wherein the first selector valve and the second selector valve are structured by a common spool valve having a common spool.

17. The oil supply device according to claim 10, wherein the second selector valve is configured to choose whether the oil passing through the common portion flows into the transmission to switch a flow destination of the oil passing through the common portion to the transmission or to the friction engagement device.

18. The oil supply device according to claim 10, wherein:
the vehicular drive transmission device further includes a rotating electrical machine provided in the power transfer path and configured to drive the wheel, and
the oil supply device further includes a third supply oil passage branching from a portion located on a downstream side of the cooler in the second supply oil passage and structured such that the oil passing through the cooler is supplied to the rotating electrical machine.

19. The oil supply device according to claim 10, wherein the first selector valve and the second selector valve are structured by a common spool valve having a common spool.

20. The oil supply device according to claim 11, wherein the second selector valve is configured to choose whether the oil passing through the common portion flows into the transmission to switch a flow destination of the oil passing through the common portion to the transmission or to the friction engagement device.

21. The oil supply device according to claim 11, wherein:
the vehicular drive transmission device further includes a rotating electrical machine provided in the power transfer path and configured to drive the wheel, and
the oil supply device further includes a third supply oil passage branching from a portion located on a downstream side of the cooler in the second supply oil passage and structured such that the oil passing through the cooler is supplied to the rotating electrical machine.

22. The oil supply device according to claim 11, wherein the first selector valve and the second selector valve are structured by a common spool valve having a common spool.

23. The oil supply device according to claim 12, wherein the second selector valve is configured to choose whether the oil passing through the common portion flows into the transmission to switch a flow destination of the oil passing through the common portion to the transmission or to the friction engagement device.

24. The oil supply device according to claim 12, wherein:
the vehicular drive transmission device further includes a rotating electrical machine provided in the power transfer path and configured to drive the wheel, and
the oil supply device further includes a third supply oil passage branching from a portion located on a downstream side of the cooler in the second supply oil passage and structured such that the oil passing through the cooler is supplied to the rotating electrical machine.

25. The oil supply device according to claim 12, wherein the first selector valve and the second selector valve are structured by a common spool valve having a common spool.

26. The oil supply device according to claim 13, wherein:
the vehicular drive transmission device further includes a rotating electrical machine provided in the power transfer path and configured to drive the wheel, and
the oil supply device further includes a third supply oil passage branching from a portion located on a downstream side of the cooler in the second supply oil passage and structured such that the oil passing through the cooler is supplied to the rotating electrical machine.

27. The oil supply device according to claim 13, wherein the first selector valve and the second selector valve are structured by a common spool valve having a common spool.

28. The oil supply device according to claim 13, wherein the first selector valve, the second selector valve, and the third selector valve are structured by a common spool valve having a common spool.

29. The oil supply device according to claim 28, wherein:
the common spool valve is configured to switch a first state and a second state depending on a position of the spool,
in the first state, the oil discharged from the first pump is cooled by the cooler and then supplied to the transmission, and the oil discharged from the second pump is supplied to the connection oil passage, and
in the second state, the oil discharged from the first pump is supplied to the transmission through the bypass oil passage, and the oil discharged from the second pump is cooled by the cooler and then supplied to the friction engagement device.
